(19) United States
(12) Patent Application Publication
(10) Pub. No.: US 2023/0401558 A1
(43) Pub. Date: Dec. 14, 2023

(54) SYSTEMS AND METHODS FOR MESSAGE-ENABLED TRANSFERS

(71) Applicant: Wells Fargo Bank, N.A., San Francisco, CA (US)

(72) Inventor: Alan W. Hecht, Chanhassen, MN (US)

(73) Assignee: Wells Fargo Bank, N.A., San Francisco, CA (US)

(21) Appl. No.: 18/209,254

(22) Filed: Jun. 13, 2023

Related U.S. Application Data
(60) Provisional application No. 63/352,172, filed on Jun. 14, 2022.

(51) Int. Cl. G06Q 20/32; G06Q 20/10

(52) U.S. Cl. CPC G06Q 20/3255; G06Q 20/102

(57) ABSTRACT

A method includes: receiving, by a provider computing system, customer information associated with a customer from a biller computing system; transmitting, by the provider computing system, a transfer request message to a customer device; generating, by the provider computing system, a transfer user interface accessible by the customer device via an embedded link within the transfer request message, the transfer user interface including a plurality of transfer preference options based on the customer information; receiving, by the provider computing system, a selected transfer preference option from the customer device; and initiating, by the provider computing system, a transfer from a customer account associated with the customer to a biller account associated with a biller based on the selected transfer preference option.

### CROSS-REFERENCE TO RELATED PATENT APPLICATION

This application claims the benefit of and priority to U.S. Provisional Patent Application No. 63/352,172, entitled “SYSTEMS AND METHODS FOR MESSAGE-ENABLED TRANSFERS,” filed Jun. 14, 2022, which is incorporated herein by reference in its entirety.

### TECHNICAL FIELD

The present disclosure relates to systems and methods for message-enabled transfers.

### BACKGROUND

Requests for payment (RFPs) have traditionally been used to enable a wide variety of transfers. For example, billers (e.g., television providers, phone providers, and other product or service providers) have utilized RFPs to send bills to customers. However, younger generations tend to prefer and have migrated to biller-direct solutions as compared to traditional bill pay options. These people like biller-direct solutions because they can time their payments strategically. Billers (e.g., telecom providers, etc.) typically prefer ACH, but do not like the exception processes (non-sufficient funds, wrong auto-pay, etc.) and the interchange fees associated with card-based transactions.

### SUMMARY

One embodiment relates to a method. The method includes receiving, by a provider computing system, customer information associated with a customer from a biller computing system. The method further includes transmitting, by the provider computing system, a transfer request message to a customer device. The method further includes generating, by the provider computing system, a transfer user interface accessible by the customer device via an embedded link within the transfer request message, the transfer user interface including a plurality of transfer preference options based on the customer information. The method further includes receiving, by the provider computing system, a selected transfer preference option from the customer device. The method further includes initiating, by the provider computing system, a transfer from a customer account associated with the customer to a biller account associated with a biller based on the selected transfer preference option.

Another embodiment relates to a provider computing system. The provider computing system includes one or more processing circuits including one or more processors and one or more memories having instructions stored thereon that, when executed by the one or more processors, cause the one or more processors to receive customer information associated with a customer from a biller computing system associated with a biller. The instructions, when executed by the one or more processors, further cause the one or more processors to transmit a transfer request message to a customer device. The instructions, when executed by the one or more processors, further cause the one or more processors to generate a transfer user interface accessible by the customer device via an embedded link within the transfer request message, the transfer user interface including a plurality of transfer preference options based on the customer information. The instructions, when executed by the one or more processors, further cause the one or more processors to receive a selected transfer preference option from the customer device. The instructions, when executed by the one or more processors, further cause the one or more processors to initiate a transfer from a customer account associated with the customer to a biller account associated with the biller based on the selected transfer preference option.

Still another embodiment relates to one or more non-transitory computer-readable media. The one or more non-transitory computer-readable media have instructions stored thereon that, when executed by one or more processing circuits of a provider computing system associated with a provider, cause operations including receiving customer information associated with a customer from a biller computing system associated with a biller. The operations further include transmitting a transfer request message to a customer device. The operations further include generating a transfer user interface accessible by the customer device via an embedded link within the transfer request message, the transfer user interface including a plurality of transfer preference options based on the customer information. The operations further include receiving a selected transfer preference option from the customer device. The operations further include initiating a transfer from a customer account associated with the customer to a biller account associated with the biller based on the selected transfer preference option.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements. Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the invention may be combined with one or more features of a different aspect of the invention. Moreover, additional features may be recognized in certain embodiments and/or implementations that may not be present in all embodiments or implementations.

### BRIEF DESCRIPTION OF THE FIGURES

FIG. 1 is a block diagram of a computing environment for enabling various message-enabled transfer services, according to an example embodiment.

FIG. 2 is flow diagram of a method for assessing a customer's eligibility for a message-enabled transfer service, according to an example embodiment.

FIG. 3 is flow diagram of a method for performing a message-enabled transfer process, according to an example embodiment.

FIG. 4 is flow diagram of a method for performing a repayment process associated with a message-enabled transfer service, according to an example embodiment.

FIG. 5 is flow diagram of a method for registering and maintaining a biller receivables account associated with a message-enabled transfer service, according to an example embodiment.

FIG. 6 is flow diagram of a method for identifying and correcting fraudulent transfers associated with a message-enabled transfer service, according to an example embodiment.

FIG. 7 depicts a messaging user interface associated with a message-enabled transfer service, according to an example embodiment.

FIG. 8 depicts an “opt in” user interface associated with a message-enabled transfer service, according to an example embodiment.

FIG. 9 depicts a transfer user interface associated with a message-enabled transfer service, according to an example embodiment.

### DETAILED DESCRIPTION

Referring generally to the figures, systems and methods for processing message-enabled transfers between various entities are disclosed. In some instances, the systems and methods described herein allow for a biller to send a transfer request message to a customer that allows the customer to access and view (e.g., via an associated customer device) a transfer user interface that provides a corresponding request for payment (RFP) to the customer. Beneficially, the systems and methods described herein allow for the customer to select between various eligible transfer methods (e.g., payment methods) across a variety of corresponding transfer rails (e.g., payment rails) to use when making a transfer (e.g., a payment) to the biller. The customer is further allowed to select between a one-time transfer or a recurring transfer, depending on the type of bill associated with the RFP. Accordingly, the systems and methods described herein beneficially allow for customers to select their preferred transfer method and corresponding transfer rail (e.g., an account clearinghouse (ACH) rail, a real-time payment (RTP) rail, a credit or debit card rail) to use when providing a transfer (e.g., payment) to a biller.

Additionally, the systems and methods described herein beneficially allow for a biller receivables account to be provided to the biller and monitored to allow for the tracking of various transfers (e.g., bill payments) using a variety of different transfer methods over a variety of different payment rails within a single system (e.g., a biller provider institution computing system associated with a biller provider institution of the biller). By tracking and compiling various transfer information over a variety of transfer methods and payment rails within a single system, the single system (e.g., the biller provider institution computing system) mitigates the need to pull in or otherwise retrieve bill-pay information from separate, disparate systems, and thus requires less bandwidth usage and power consumption, as compared to other electronic accounts receivables systems that would need to pull in or otherwise retrieve the bill-pay information.

Further, the systems and methods described herein beneficially allow for cross-rail fraud detection. That is, because the systems and methods described herein allow for the tracking of various transfers using a variety of payment methods over a variety of different payment rails within a single system, a high velocity of transfers across multiple payment methods and corresponding payment rails associated with a single customer may be detected and flagged as potentially fraudulent. Beneficially, this prevents potential fraudsters who gain access to multiple customer accounts associated with differing payment rails (e.g., via a data breach of the customer's mobile device) from rotating between payment methods on different payment rails when conducting fraudulent transfers to avoid detection.

Technically and beneficially, the systems, methods, and apparatuses described herein thus provide enhanced security as compared to traditional transfer systems by allowing for the cross-rail fraud detection referenced above. The systems, method, and apparatuses described herein further provide more efficient (i.e., less computationally burdensome and power intensive) tracking and compiling of transfer information over a variety of transfer methods and payment rails as compared to traditional transfer systems by allowing for the variety of transfer methods and payment rails to be utilized within a single system, as also referenced above.

Before turning to the figures, which illustrate certain example embodiments in detail, it should be understood that the present disclosure is not limited to the details or methodology set forth in the description or illustrated in the figures. It should also be understood that the terminology used herein is for the purpose of description only and should not be regarded as limiting.

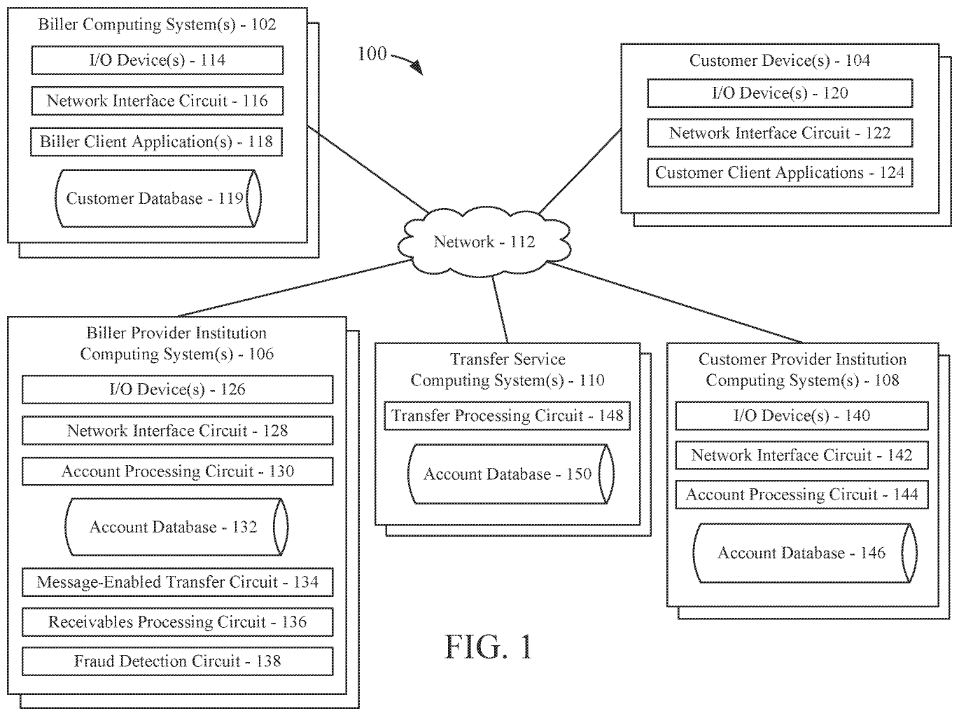

FIG. 1 is a diagram of a message-enabled transfer computing environment 100 for processing message-enabled transfers of resources between various entities. As shown, the message-enabled transfer computing environment 100 includes one or more biller computing systems 102, one or more customer devices 104, one or more biller provider institution computing systems 106, one or more customer provider institution computing systems 108, and a transfer service computing system 110. The biller computing system(s) 102, the biller provider institution system(s) 106, the customer provider institution computing system(s) 108, and the transfer service computing system 110 are in communication with each other and are connected by a network 112.

For clarity, the following description will refer to a biller computing system 102, a customer device 104, a biller provider institution computing system 106, a customer provider institution computing system 108, and a transfer service computing system 110. However, it will be understood that the following description of any of these devices and computing systems will be similarly applicable to any additional corresponding devices and computing systems (e.g., additional biller computing systems 102, customer devices 104, biller provider institution computing systems 106, customer provider institution computing systems 108, and transfer service computing systems 110) and that, in some embodiments, the computing environment 100 may include a plurality of any of the described devices and systems.

The biller computing system 102 is owned, operated, controlled, managed, and/or otherwise associated with a corresponding biller (e.g., a product and/or service provider, a merchant associated with a point of sale (POS) location). The biller may be any company, entity, or other institution that provides a service and/or product to or otherwise has a reason to provide bills or requests for payments (RfPs) to customers. For example, in some instances, the biller may be a merchant, a power company provider, a telephone service provider, an internet service provider, a cable provider, a lawn care service provider, a fitness service provider (e.g., a gym), and/or any other relevant type of company or institution.

The biller computing system 102 may comprise one or more servers or other computing systems, each with one or more processing circuits having one or more processors configured to execute instructions stored in one or more memory devices. In some embodiments, the biller computing system 102 is structured as a backend computing system. For example, in some instances, the biller computing system 102 is a backend computing system associated with a product or service provider. In some instances, the biller computing system 102 may comprise and/or have various other devices communicably coupled thereto, such as, for example, desktop or laptop computers, smartphones, tablet computers, wearable devices (e.g., smartwatches), and/or other suitable devices. For example, in some instances, the biller computing system 102 may comprise or be communicably coupled to a computing system associated with a POS location of a merchant.

In some embodiments, the biller computing system 102 includes one or more input/output (I/O) devices 114, a network interface circuit 116, one or more biller client applications 118, and a customer database 119. The I/O devices 114 are configured to receive inputs from and display information to a user of the biller computing system 102 or an attendant associated with the biller. While the term “I/O” is used, it should be understood that the I/O devices 114 may be input-only devices, output-only devices, and/or a combination of input and output devices.

The network interface circuit 116 includes, for example, program logic and various devices (e.g., transceivers, etc.) that connect the biller computing system 102 to the network 112. The network interface circuit 116 facilitates secure communications between the biller computing system 102 and each of the customer device 104, the biller provider institution computing system 106, the customer provider institution computing system 108, and the transfer service computing system 110. The network interface circuit 116 also facilitates communication with other entities, such as other banks, settlement systems, and so on. The network interface circuit 116 may further include user interface program logic configured to generate and present web pages to users accessing the biller computing system 102 over the network 112.

The biller computing system 102 stores in computer memory, and executes (“runs”) using one or more processors, various biller client applications 118, such as an Internet browser presenting websites, text messaging applications (e.g., for sending MMS or SMS to the customer device 104), and/or applications provided or authorized by entities implementing or administering any of the computing systems in computing environment 100.

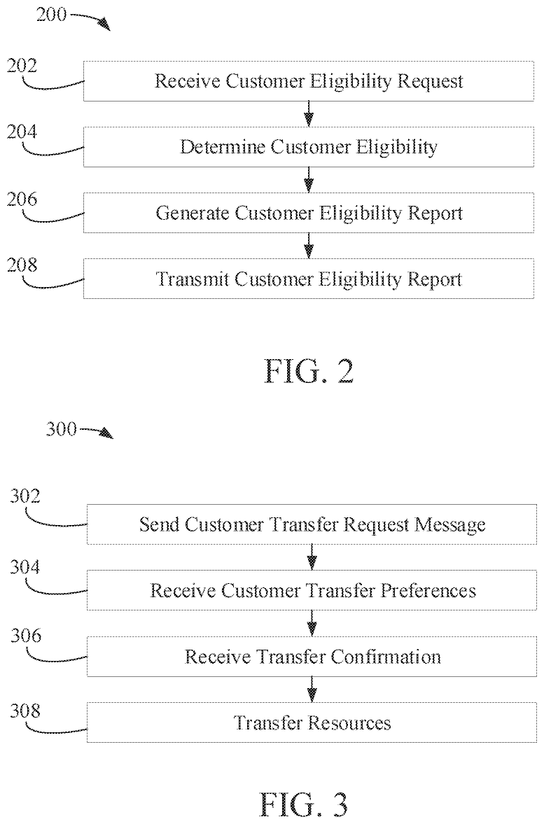

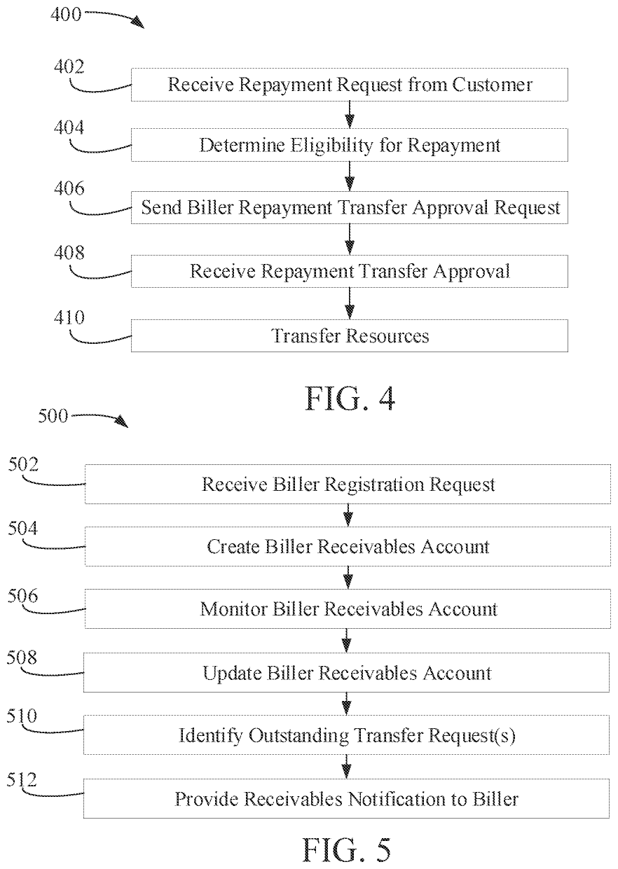

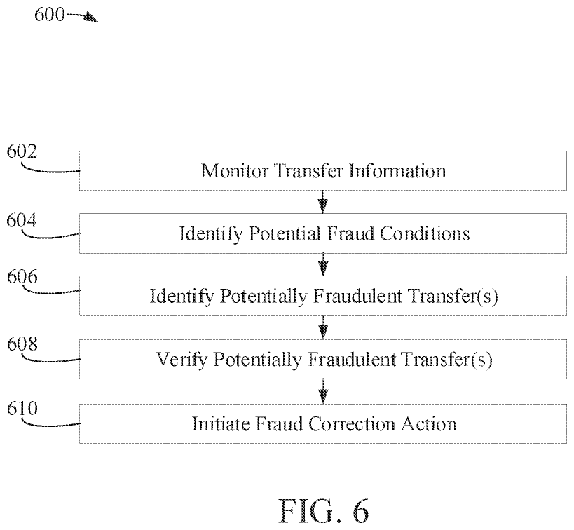

For example, in some instances, the biller client application 118 comprises a biller provider institution application (e.g., a financial institution banking application) provided by and at least partly supported by the biller provider institution computing system 106. Thus, in some instances, the biller client application 118 is coupled to the biller provider institution computing system 106 and enables various functionality described herein. For example, in some instances, the biller client application 118 enables the biller to transmit a customer eligibility request to the biller provider institution computing system 106, as described in detail below with respect to FIG. 2. In some instances, the biller client application 118 enables the biller to generate a transfer request message for sending to the customer device 104, as described in detail below with respect to FIG. 3. In some instances, the biller client application 118 enables the biller to approve customer repayment requests, as described in detail below with respect to FIG. 4. In some instances, the biller client application 118 enables the biller to register for and manage a biller receivables account held at the biller provider institution associated with the biller provider institution computing system 106, as described in detail below with respect to FIG. 5. In some instances, the biller client application 118 enables the biller to verify or otherwise determine the validity of potentially fraudulent transfers identified by the biller provider institution computing system 106, as described in detail below with respect to FIG. 6.

The customer database 119 stores various customer information associated with customers of the biller. For example, in some instances, the biller computing system 102 receives and stores the various customer information within the customer database 119 upon the customer registering for a product or service provided by the biller. In some instances, the biller computing system 102 receives the various customer information via a transmission from the customer device 104 via the network 112. For example, if the biller is a service provider, the customer may register for the service provided by the biller using the customer device 104 and the registration process may include the customer providing various customer information, along with a registration request, to the biller computing system 102. In some instances, the customer information includes customer identifying information (e.g., a name, a phone number, an e-mail address, a physical address) and customer transfer information (e.g., a bank routing number, a bank account number, a transfer service identifier associated with the customer).

The customer device 104 is owned, operated, controlled, managed, and/or otherwise associated with a customer. For example, in some instances, the customer is a customer of the biller associated with the biller computing system 102. In some embodiments, the customer device 104 may be or may comprise, for example, a desktop or laptop computer, a smartphone, a tablet computer, a wearable device (e.g., a smartwatch), a personal digital assistant, and/or any other suitable computing device.

In some embodiments, the customer device 104 includes one or more I/O devices 120, a network interface circuit 122, and one or more customer client applications 124. Again, while the term “I/O” is used, it should be understood that the I/O devices 120 may be input-only devices, output-only devices, and/or a combination of input and output devices. In some instances, the I/O devices 120 include various devices that provide perceptible outputs (such as display devices with display screens and/or light sources for visually-perceptible elements, an audio speaker for audible elements, and haptics or vibration devices for perceptible signaling via touch, etc.), that capture ambient sights and sounds (such as digital cameras, microphones, etc.), and/or that allow the customer to provide inputs (such as a touchscreen display, stylus, keyboard, force sensor for sensing pressure on a display screen, etc.). In some instances, the I/O devices 120 further comprise one or more user interfaces (devices or components that interface with the customer), which may include one or more biometric sensors (such as a fingerprint reader, a heart monitor that detects cardiovascular signals, face scanner, an iris scanner, etc.).

The network interface circuit 122 includes, for example, program logic and various devices (e.g., transceivers, etc.) that connect the customer device 104 to the network 112. The network interface circuit 122 facilitates secure communications between the customer device 104 and each of the biller computing system 102, the biller provider institution computing system 106, the customer provider institution computing system 108, and the transfer service computing system 110. The network interface circuit 122 also facilitates communication with other entities, such as other banks, settlement systems, and so on.

The customer device 104 stores in computer memory, and executes (“runs”) using one or more processors, various customer client applications 124, such as an Internet browser presenting websites, text messaging applications (e.g., for sending MMS or SMS to the biller computing system 102 and/or the biller provider institution computing system 106), and/or applications provided or authorized by entities implementing or administering any of the computing systems in computing environment 100.

For example, in some instances, the customer client applications 124 comprise a customer provider institution application (e.g., a financial institution banking application) provided by and at least partly supported by the customer provider institution computing system 108. Thus, in some instances, the customer client application 124 coupled to the customer provider institution computing system 108 may enable account management regarding one or more accounts held at the customer provider institution associated with the customer provider institution computing system 108 (e.g., funds transfers, bill payment, etc.).

In some instances, the customer client applications 124 further comprise a biller application provided by and at least partly supported by the biller computing system 102. In these instances, the customer client application 124 is coupled to the biller computing system 102 and enables various functionality described herein. For example, in some embodiments, the customer client application 124 enables the customer to provide various transfer eligibility information to the biller computing system 102, as described in detail below with respect to FIG. 2. In some embodiments, the customer client application 124 enables the customer to receive a transfer request from the biller computing system 102 and to provide transfer preferences and a transfer confirmation to the biller computing system 102, as described in detail below with respect to FIG. 3. In some embodiments, customer client application 124 enables the customer to transmit a repayment request to the biller computing system 102, as described in detail below with respect to FIG. 4.

In some instances, the customer client applications 124 further comprise a biller provider institution application provided by and at least partially supported by the biller provider institution computing system 106. Thus, in some instances, the biller client application 118 is coupled to the biller provider institution computing system 106 and enables various functionality described herein. For example, in some instances, the customer client application 124 enables the customer to provide various transfer eligibility information to the biller provider institution computing system 106, as described in detail below with respect to FIG. 2. In some embodiments, the customer client application 124 enables the customer to receive a transfer request from the biller provider institution computing system 106 and to provide transfer preferences and a transfer confirmation to the biller provider institution computing system 106, as described in detail below with respect to FIG. 3. In some embodiments, customer client application 124 enables the customer to transmit a repayment request to the biller provider institution computing system 106, as described in detail below with respect to FIG. 4.

The biller provider institution computing system 106 is operated by a provider institution (e.g., a bank or other financial institution) that maintains one or more accounts held by various customers (e.g., the biller associated with the biller computing system 102), such as demand deposit accounts, credit card accounts, receivables accounts, and so on. In some instances, the biller provider institution computing system 106, for example, may comprise one or more servers, each with one or more processing circuits having one or more processors configured to execute instructions stored in one or more memory devices to send and receive data stored in the one or more memory devices and perform other operations to implement the methods described herein associated with logic or processes shown in the figures. In some instances, the biller provider institution computing system 106 may comprise and/or have various other devices communicably coupled thereto, such as, for example, desktop or laptop computers, smartphones, tablet computers, wearable devise (e.g., smartwatches), and/or other suitable devices.

In some embodiments, the biller provider institution computing system 106 includes one or more I/O devices 126, a network interface circuit 128, an account processing circuit 130, an account database 132, a message-enabled transfer circuit 134, a receivables processing circuit 136, and a fraud detection circuit 138. The one or more I/O devices 126 are configured to receive inputs from and display information to a user. For example, the I/O devices 126 may be substantially similar to the I/O devices 114 of the biller computing system 102 discussed above.

In some instances, the network interface circuit 128 includes, for example, program logic that connects the biller provider institution computing system 106 to the network 112. The network interface circuit 128 facilitates secure communications between the biller provider institution computing system 106 and each of the biller computing system 102, the customer device 104, the customer provider institution computing system 108, and the transfer service computing system 110. The network interface circuit 128 also facilitates communication with other entities, such as other banks, settlement systems, and so on. The network interface circuit 128 further includes user interface program logic configured to generate and present web pages to users accessing the biller provider institution computing system 106 over the network 112.

The account processing circuit 130 performs account processing to process transactions in connection with the account(s) stored within an account database 132, such as account credits and debits to checking and savings accounts, credits and debits to home mortgage and home equity accounts, credits and debits to student loan accounts, and so on. Thus, when funds are transferred into or out of an account, the account processing circuit 130 is configured to track the transaction and modify an entry/ledger in the account database 132 to reflect the debit or credit.

The account database 132 stores account information (e.g., transaction information, information about the account holder, information pertaining to the type and corresponding capabilities of a given account, and so on) for accounts that are maintained by the biller provider institution on behalf of its customers. The account database 132 is configured to be used by the account processing circuit 130 to identify various accounts associated with various transfers (e.g., funds transfers).

The message-enabled transfer circuit 134, the receivables processing circuit 136, and the fraud detection circuit 138 are configured to enable various functionalities described herein. For example, in some instances, the message-enabled transfer circuit 134 is configured to perform various functionalities associated with assessing a customer's eligibility for message-enabled payments, as described in detail below, with respect to FIG. 2. In some instances, the message-enabled transfer circuit 134 is configured to perform various functionalities associated with a message-enabled payment process, as described in detail below, with respect to FIG. 3. In some instances, the message-enabled transfer circuit 134 is configured to perform various functionalities associated with a message-enabled repayment process, as described in detail below, with respect to FIG. 4. In some instances, the receivables processing circuit 136 is configured to perform various functionalities associated with registering and maintaining a biller receivables account, as described in detail below, with respect to FIG. 5. In some instances, the fraud detection circuit 138 is configured to perform various functionalities associated with identifying and correcting fraudulent transfers, as described in detail below, with respect to FIG. 6.

The customer provider institution computing system 108 is operated by a provider institution (e.g., a bank or other financial institution) that maintains accounts held by various customers (e.g., the customer associated with the customer device 104), such as demand deposit accounts, mortgage account, credit card accounts, and so on. In some embodiments, the customer provider institution computing system 108 and the biller provider institution computing system 106 are owned by, operated by, managed by, and/or otherwise controlled by the same provider institution. In these embodiments, the provider institution may hold or manage accounts of the biller and the customer. In some embodiments, the customer provider institution computing system 108 and the biller provider institution computing system 106 are owned by, operated by, managed by, and/or otherwise controlled by different provider institutions (e.g., Bank A versus Bank B).

In some instances, the customer provider institution computing system 108, for example, may comprise one or more servers, each with one or more processing circuits having one or more processors configured to execute instructions stored in one or more memory devices, send and receive data stored in the one or more memory devices, and perform other operations to implement the operations described herein associated with logic or processes shown in the figures. In some instances, the customer provider institution computing system 108 may comprise and/or have various other devices communicably coupled thereto, such as, for example, desktop or laptop computers, smartphones, tablet computers, wearable devise (e.g., smartwatches), and/or other suitable devices.

In some embodiments, the customer provider institution computing system 108 includes one or more I/O devices 140, a network interface circuit 142, an account processing circuit 144, and an account database 146. The one or more I/O devices 140 are configured to receive inputs from and display information to a user. For example, the I/O devices 126 may be substantially similar to the I/O devices 114, 126 of the biller computing system 102 and the biller provider institution computing system 106 discussed above.

In some instances, the network interface circuit 142 includes, for example, program logic that connects the customer provider institution computing system 108 to the network 112. The network interface circuit 142 facilitates secure communications between the customer provider institution computing system 108 and each of the biller computing system 102, the customer device 104, the biller provider institution computing system 106, and the transfer service computing system 110. The network interface circuit 142 also facilitates communication with other entities, such as other banks, settlement systems, and so on. The network interface circuit 142 further includes user interface program logic configured to generate and present web pages to users accessing the customer provider institution computing system 108 over the network 112.

The account processing circuit 144 performs account processing to process transactions in connection with the account(s) stored within an account database 146, such as account credits and debits to checking and savings accounts, credits and debits to home mortgage and home equity accounts, credits and debits to student loan accounts, and so on. Thus, when funds are transferred into or out of an account of an account holder (e.g., the customer), the account processing circuit 144 is configured to track the transaction and modify an entry/ledger in the account database 146 to reflect the debit or credit.

The account database 146 stores account information (e.g., transaction information, information about the account holder, information pertaining to the type and corresponding capabilities of a given account, and so on) for accounts that are maintained by the customer provider institution on behalf of its customers. The account database 146 is configured to be used by the account processing circuit 144 to identify various accounts associated with various funds transfers.

The transfer service computing system 110 is controlled by, managed by, owned by, and/or otherwise associated with a transfer service entity (e.g., Zelle®) that is configured to enable real-time or nearly real-time transfers. As described herein and in one embodiment, the “transfer” is a payment or fund transfer. However, the present disclosure is also applicable with other types of transfers, such as the secure transfer of information (e.g., documents). The payment or fund transfer may include electronic or digital fund transfers.

In some instances, the transfer service entity may be a financial institution (e.g., a card network) or other entity that supports transfers across multiple different entities (e.g., across different financial institutions). In some instances, the transfer service entity may, for example, be an entity that is formed as a joint venture between banks and/or other entities that send and receive funds using the computing environment 100. As another example, the transfer service entity may be a third party vendor. As still another example, the transfer service entity may be provided by one of the provider institutions, such that the provider institution performs both the operations described herein as being performed by the biller provider institution computing systems 106 or the customer provider institution computing system 108 and the operations described herein as being performed by the transfer service computing system 110.

The transfer service computing system 110 is configured, in various embodiments, to provide (e.g., through its own client application or through integration with a client application of another entity, such as a banking application) at least some of the functionality depicted in the figures and described herein (e.g., enabling transfers between the biller and the customer). For example, in some instances, the transfer service entity provides or hosts a web portal provided for an online community of individuals where such individuals obtain user names/login IDs or otherwise become registered members to enable real-time or nearly real-time transfers between senders and recipients (e.g., between the biller and the customer).

In some instances, at least some of the functionality performed by the transfer service computing system 110 is integrated within a banking application (e.g., one of the customer client applications 124) provided by the biller provider institution computing system 106 or the customer provider institution computing system 108 to the customer device 104. For example, in some instances, the transfer service computing system 110 includes one or more APIs that securely communicate with the biller provider institution computing system 106 and/or the customer provider institution computing system 108 and allow for various functionality performed by the transfer service computing system 110 to be embedded within the customer client application 124 provided by the biller provider institution computing system 106 or the customer provider institution computing system 108 to the customer device 104.

In some embodiments, transfer service computing system 110 may, for example, comprise one or more servers, each with one or more processing circuits including one or more processors configured to execute instructions stored in one or more memory devices, send and receive data stored in the one or more memory devices, and perform other operations to implement the operations described herein associated with certain logic and/or processes depicted in the figures. Although not specifically shown, it will be appreciated that the transfer service computing system 110 may include a network interface circuit, various databases, an account processing circuit, and other circuits in the same or similar manner to the other components of computing environment 100. In some instances, the network interface circuit may include user interface program logic configured to generate and present application pages, web pages, and/or various other data to users accessing the transfer service computing system 110 over the network 112.

The transfer processing circuit 148 is configured to enable real-time or near real-time transfers between registered users of the transfer service (e.g., the biller and the customer). For example, in some instances, during a registration process, the transfer service computing system 110 is configured to receive one or more transfer service identifiers (e.g., a Zelle® identifier), such as a phone number, an e-mail address, an alphanumeric tag, etc., to be associated with an entity (e.g., the biller or the customer) registering for the transfer service. During the registration process, the transfer service computing system 110 is further configured to receive various account information (e.g., a bank routing number, a bank account number) and identifying information (e.g., a name, a phone number, an e-mail address, a physical address) associated with the entity to be linked to the corresponding received transfer service identifier(s) for registering the entity with the transfer service.

Accordingly, in some instances, the transfer service computing system 110 is configured to receive a registration request from the biller computing system 102 and/or the customer device 104 to register the biller and/or the customer. In some instances, the registration request includes a desired transfer service identifier, the account information, and the identifying information associated with the biller or the customer. Upon receiving the registration request, the transfer service computing system 110 is configured to store the transfer service identifier, the account information, and the identifying information for the biller and/or the customer within an account database 150 and to link the transfer service identifier to the account information and the identifying information within the account database 150 to register the biller and/or the customer with the transfer service.

Once the transfer service identifier, the account information, and the identifying information for the biller and/or customer have been stored and linked within the account database 150, the transfer processing circuit 148 is configured to, upon receipt of a transfer request (e.g., received from the biller computing system 102, the customer device 104, the biller provider institution computing system 106, or the customer provider institution computing system 108), query the account database 150 to retrieve the corresponding account information and identifying information associated with recipient and sender transfer service identifiers included in the requested transfer. Once the corresponding account information is successfully retrieved by the transfer processing circuit 148, the transfer processing circuit 148 is configured to initiate a transfer (e.g., of funds) from an account associated with the sender (e.g., the customer) to an account associated with the recipient (e.g., the biller).

As discussed above, the account database 150 stores transfer service identifiers, corresponding account information, and corresponding identifying information for various transfer service accounts that are maintained by the transfer service on behalf of its customers. The account database 150 is configured to be used by the transfer processing circuit 148 to enable the real-time or near real-time transfers discussed above.

With an example structure of the computing environment 100 being described above, example processes performable by the computing environment 100 (or components/systems thereof) will be described below. It should be appreciated that the following processes are provided as examples and are in no way meant to be limiting. Additionally, various method steps discussed herein may be performed in a different order or, in some instances, completely omitted. These variations have been contemplated and are within the scope of the present disclosure.

Referring to FIG. 2, a flow diagram of a method 200 for assessing a customer's eligibility for the message-enabled transfer service is shown, according to an example embodiment. Various operations of the method 200 may be conducted by the message-enabled transfer computing environment 100 (e.g., the biller computing system 102, the customer device 104, the biller provider institution computing system 106, the customer provider institution computing system 108, and the transfer service computing system 110).

As shown, the method 200 begins by the biller provider institution computing system 106 receiving a customer eligibility request, at step 202. The customer eligibility request refers to a message (e.g., a text, an e-mail, a selection indication provided via a user interface of a biller client application 118) from the biller to the biller provider institution requesting an indication of a given customer's eligibility for the message-enabled transfer service. For example, in some instances, the biller computing system 102 is associated with a point of sale and the customer device 104 is associated with a customer attempting to make a purchase at the point of sale. In some of these instances, the biller computing system 102 is configured to send the customer eligibility request to the biller provider institution computing system 106 (e.g., to the message-enabled transfer circuit 134) in response to an input received (e.g., via the I/O device 114 or an I/O device associated with a point of sale computing system communicably coupled to the biller computing system 102) by the biller computing system 102 from an employee of the point of sale location.

For example, via the input, various customer transfer information (e.g., bank routing numbers, bank account numbers, payment tokens, transfer service identifiers) associated with the customer may be provided within the customer eligibility request sent by the biller computing system 102 to the biller provider institution computing system 106 (particularly, to the message-enabled transfer circuit 134). In some instances, an employee may input the various customer transfer information based on verbally provided information received from the customer. In some other instances, the employee may instead allow the customer to directly enter the customer transfer information via the I/O device associated with the point of sale computing system communicably coupled to the biller computing system 102.

In some instances, when the customer is attempting to make a purchase at the point of sale, the customer device 104 is configured to send the customer eligibility request to the biller provider institution computing system 106 (particularly, to the message-enabled transfer circuit 134) in response to an input received (e.g., via I/O devices 120) from the customer. For example, in some instances, the biller may have a quick-response (QR) code displayed near a POS device associated with the biller computing system 102. The POS device may indicate to the customer (e.g., audibly or via a displayed message near the QR code) that the customer can scan the QR code using the customer device 104 or tap the customer device 104 to the NFC device to have their eligibility for message-enabled transfers assessed (e.g., via the biller provider institution computing system 106) and provided to the biller computing system 102.

In some instances, upon the customer scanning the QR code or tapping the NFC device with the customer device 104, the customer device 104 is configured to generate and display an eligibility graphical user interface (e.g., generated and provided to the customer device 104 by the message-enabled transfer circuit 134 of the biller provider institution computing system 106 via the network 112) to the customer that allows for the customer to provide the biller provider institution computing system 106 with a biller identification associated with the biller and customer transfer information associated with the customer (e.g., bank routing numbers, bank account numbers, transfer service identifiers) to be used by the biller provider institution computing system 106 (e.g., the message-enabled transfer circuit 134) in performing the customer eligibility determination. Accordingly, upon the customer entering the biller identification (e.g., a biller ID number associated with the biller, the biller's company name, an alphanumeric tag associated with the biller, etc.) and the customer transfer information into the eligibility graphical user interface, the customer device 104 is configured to generate and send the customer eligibility request, including the biller identification and the customer transfer information, to the biller provider institution computing system 106.

In some instances, the biller computing system 102 is associated with a product and/or service provider that has recurring customers, and the customer is registered for the product or service provided by the biller. In some of these instances, the biller computing system 102 is configured to send the customer eligibility request to the biller provider institution computing system 106 (particularly, to the message-enabled transfer circuit 134) in response to an input received by the biller computing system 102 from an employee associated with the biller. For example, in some instances, the employee inputs a customer name into the biller computing system 102, and the biller computing system 102 is configured to retrieve associated customer transfer information stored within the customer database 119. The biller computing system 102 then generates and sends the customer eligibility request, including the customer transfer information, to the biller provider institution computing system 106. For example, in some instances, the customer eligibility request may take the form of a text message, an email, a push notification within a client application (e.g., the biller client application 118), and so on.

In some instances, the biller computing system 102 is configured to send the customer eligibility request to the biller provider institution computing system 106 (particularly, to the message-enabled transfer circuit 134) in response to a message-enabled transfer service request received by the biller computing system 102 from the customer device 104. For example, in some instances, the customer device 104 may be used by the customer to access a biller website or biller application hosted by the biller computing system 102. In these instances, the biller website or biller application displays a notification informing the customer of the message-enabled transfer service and providing a selectable eligibility request icon (e.g., a button or other selectable interface point). Upon the customer clicking on or otherwise interacting with the selectable eligibility request icon using the customer device 104, the biller computing system 102 is configured to retrieve customer transfer information associated with the customer from within the customer database 119 and to send the customer eligibility request to the biller provider institution computing system 106 (particularly, to the message-enabled transfer circuit 134).

In some other instances, the biller computing system 102 is configured to send the customer eligibility request to the biller provider institution computing system 106 based on a predetermined customer eligibility determination schedule provided by an employee associated with the biller (e.g., via the I/O device 114). The predetermined customer eligibility determination schedule may indicate customer eligibility for message-enabled transfers, which is assessed on a periodic basis (e.g., daily, once a week, once a month, once a year).

In still some other instances, the biller computing system 102 and/or the customer device 104 is configured to send the customer eligibility request and the customer transfer information to the biller provider institution computing system 106 in a single or multi-batch transmission (e.g., batch processing) via the network 112. In some other instances, the biller computing system 102 is configured to send the customer eligibility request to the biller provider institution computing system 106 and the biller provider institution computing system 106 (e.g., the message-enabled transfer circuit 134) is configured to, in response to receiving the customer eligibility request, automatically pull the customer transfer information from the customer database 119 via an API call enabled by an API embedded within a biller client application 118 provided to the biller computing system 102 by the biller provider institution computing system 106. In these embodiments, the embedded API is configured to provide a secure line of communication between the biller computing system 102 and the biller provider institution computing system 106 over the network 112.

Once the biller provider institution computing system 106 receives the customer eligibility request and the associated customer transfer information, the biller provider institution computing system 106 (e.g., the message-enabled transfer circuit 134) then determines the customer's eligibility for message-enabled transfers, at step 204. In some instances, using the customer transfer information, the message-enabled transfer circuit 134 is configured to initiate a predefined amount (e.g., zero-dollar, one dollar and twenty-three cents, etc.) request for payment (RFP) to validate the customer transfer information and determine the customer's eligibility for the message-enabled transfer service.

For example, in some instances, the customer transfer information includes a routing number and an account number associated with a financial account associated with the customer (e.g., an account managed and operated by the customer provider institution computing system 108). In these instances, the message-enabled transfer circuit 134 sends the predefined amount RFP to the customer provider institution computing system 108 using the routing number and the account number associated with the customer. Upon receipt, the account processing circuit 144 of the customer provider institution computing system 108 uses the account number to identify a customer account associated with the customer within the account database 146 and the customer provider institution computing system 108 initiates the predefined amount payment from the customer account to an account held at the biller provider institution associated with the biller provider institution computing system 106. If the predefined amount RFP is successful, the message-enabled transfer circuit 134 determines that the customer account associated with the routing number and the account number utilized is eligible to receive RFPs.

Further, in some instances, the message-enabled transfer circuit 134 sends multiple predefined amount RFPs associated with the same account via differing payment rails to determine, in addition to the customer account being generally eligible to receive RFPs, which types of payment rails that the customer account is eligible to receive RFPs through. For example, in some instances, the message-enabled transfer circuit 134 is configured to send zero-dollar RFPs to the account via a real-time payment (RTP) rail (e.g., for a demand deposit account or other account capable of RTPs), an automated clearinghouse (ACH) rail, the FedNow™ payment rail, a card-based payment rail, and/or any other suitable type of payment rail.

In some instances, the customer transfer information includes a transfer service identifier associated with the transfer service of the transfer service computing system 110. In some of these instances, the message-enabled transfer circuit 134 similarly sends a zero-dollar RFP to the transfer service computing system 110 to validate the transfer service identifier and determine the customer's eligibility to receive RFPs via the transfer service. For example, in these instances, the message-enabled transfer circuit 134 sends the zero-dollar transfer request to the transfer service computing system 110 via the network 112. In some instances, the zero-dollar transfer request includes a request for payment (e.g., of zero dollars or another predefined amount) from the transfer service identifier (i.e., the financial account associated with the transfer service identifier) of the customer. The transfer service computing system 110 then, upon receipt of the zero-dollar transfer request, queries the account database 150 using the transfer service identifier, identifies the customer and the customer's associated financial account within the account database 150, and initiates a transfer of funds (e.g., zero dollars) from the customer's financial account (e.g., held at the customer provider institution associated with the customer provider institution computing system 108) to an account managed by the biller provider institution associated with the biller provider institution computing system 106. Similarly, if the zero-dollar RFP is successful via the transfer service, the message-enabled transfer circuit 134 determines that the customer is eligible to receive RFPs via the transfer service identifier associated with the customer.

In some other instances, when the customer transfer information includes the transfer service identifier, the message-enabled transfer circuit 134, in lieu of or in addition to performing the zero-dollar RFP via the transfer service, the message-enabled transfer circuit 134 sends a request for validation to the transfer service computing system 110. In some instances, the request for validation includes the transfer service identifier and a request for the transfer service computing system 110 to validate that the transfer service identifier is associated with a valid transfer service account. Accordingly, in these instances, the transfer processing circuit 148 is configured to query the account database 150 to determine whether the transfer service identifier is associated with a valid transfer service account and to send an indication to the biller provider institution computing system 106 (particularly, to the message-enabled transfer circuit 134) indicating whether or not the transfer service identifier is associated with a valid transfer service account. In these instances, upon receiving an indication from the transfer service computing system 110 that the transfer service identifier is associated with a valid transfer service account, the message-enabled transfer circuit 134 determines that the customer is eligible to receive RFPs via the transfer service identifier associated with the customer.

In some embodiments, once the message-enabled transfer circuit 134 has verified the various routing numbers, account numbers, and/or transfer service identifiers, the biller provider institution computing system 106 (particularly, the message-enabled transfer circuit 134) then generates a customer eligibility report, at step 206. For example, in some instances, the message-enabled transfer circuit 134 is configured to compile a list of eligible accounts and corresponding payment rails, as well as eligible transfer service identifiers, available for the customer. The message-enabled transfer circuit 134 then generates the customer eligibility report, which includes the compiled list of eligible accounts, payment rails, and/or transfer service identifiers (e.g., the available solutions or coverage for the customer, such as RTP, ACH, pay with Zelle®, card-based payments, etc.), at step 206, and transmits the customer eligibility report to the biller computing system 102, at step 208. In some instances, in the case that the customer eligibility request was received by or initiated by the customer, the message-enabled transfer circuit 134 also transmits the customer eligibility report to the customer device 104, at step 208. In some instances, the customer eligibility report may comprise a screen or user interface provided to the biller via a client application (e.g., a biller client application 118). In some instances, the customer eligibility report may be provided in various other formats (e.g., a portable document format (PDF), a spreadsheet, a document, a text message, an e-mail, etc.).

Referring to FIG. 3, a flow diagram of a method 300 for performing a message-enabled transfer process is shown, according to an example embodiment. As shown, the method 300 begins by sending a transfer request message to the customer device 104, at step 302. In some instances, the transfer request message is sent as a text message, an e-mail message, a push notification, an instant message (e.g., via an instant-messaging application), or any other suitable type of message.

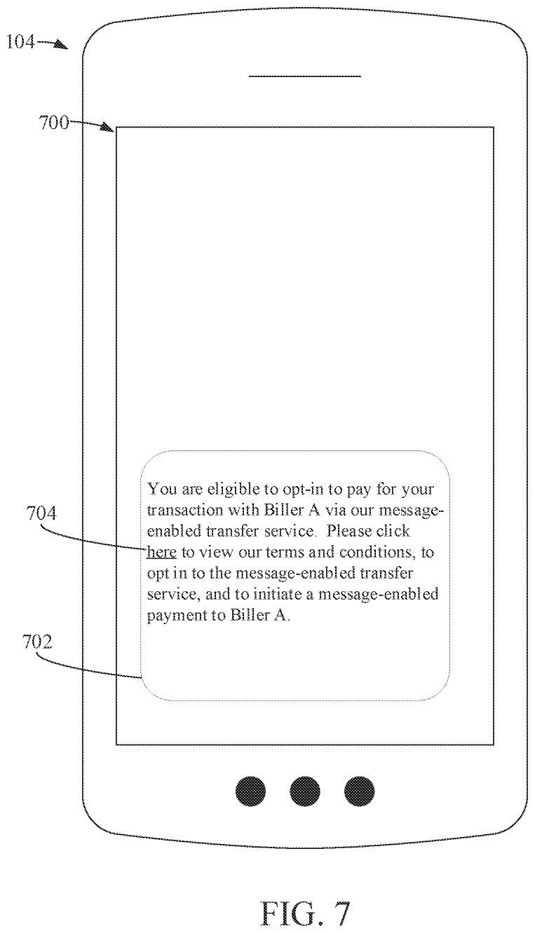

As shown in FIG. 7, in some instances, upon receipt of the transfer request message (e.g., transfer request message 702), the customer device 104 generates and displays a messaging user interface 700 including the transfer request message 702 via a display of the customer device 104. In some instances, the transfer request message 702 indicates that the customer is eligible to opt-in to a message-enabled transfer service and includes a link 704 configured to, when clicked on by the customer via the customer device 104 (e.g., via the I/O device 120), navigate the customer to a website or a banking application (e.g., the customer client application 124) managed and provided by the biller provider institution computing system 106 (e.g., the message-enabled transfer circuit 134).

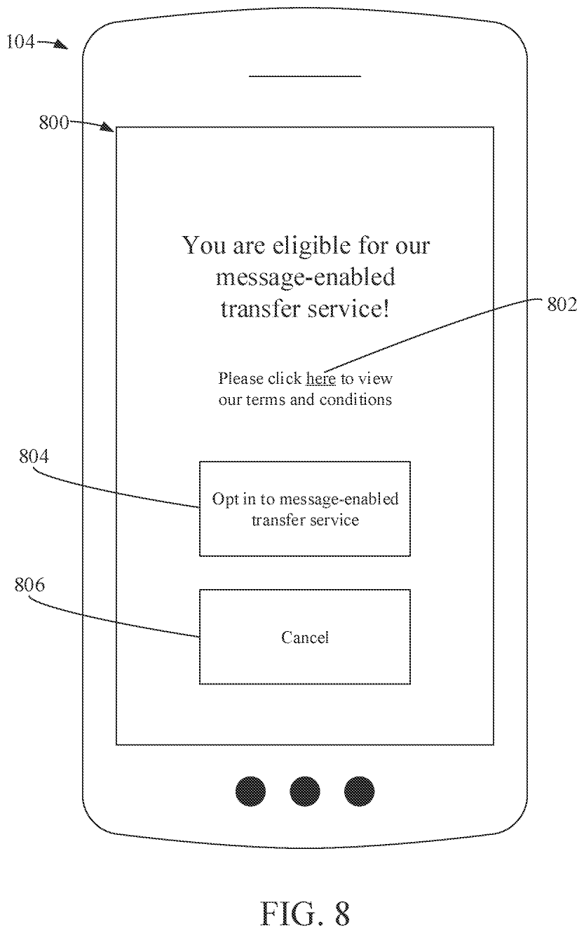

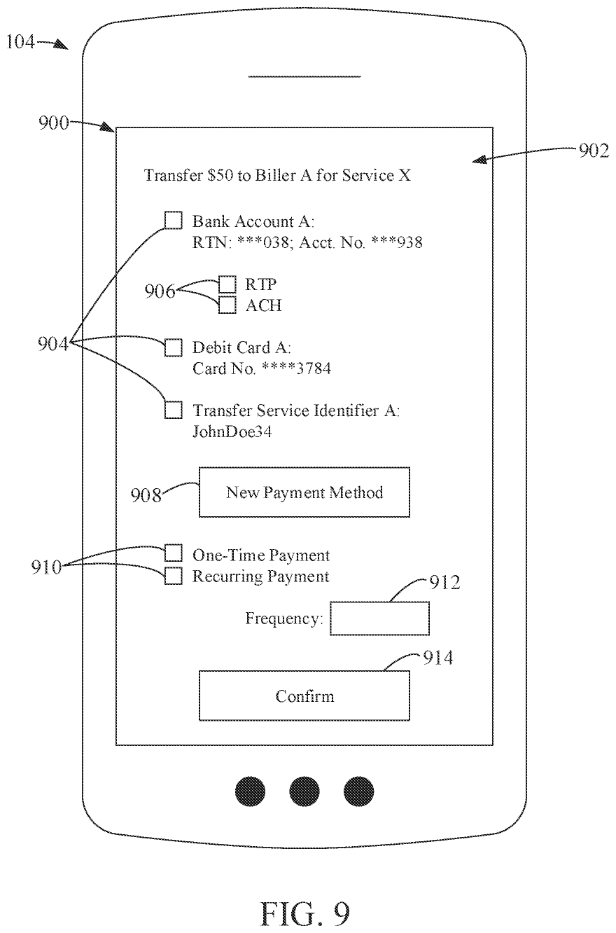

In some instances, the website or the banking application provided by the biller provider institution computing system 106 is configured to provide the customer device 104 with an “opt in” user interface (e.g., “opt in” user interface 800 shown in FIG. 8) and, upon the customer opting in to the message-enabled transfer service, a transfer user interface (e.g., transfer user interface 900 shown in FIG. 9), each similarly being generated and provided to the customer device 104 by the biller provider institution computing system 106. As will be discussed in detail below, with respect to FIGS. 8 and 9, in some instances, the “opt in” user interface allows for the customer to opt in to the message-enabled transfer service and the transfer user interface allows the customer to initiate a message-enabled transfer from the customer (e.g., a financial account associated with the customer) to the biller (e.g., a financial account associated with the biller) for a given bill or transaction.

In some instances, the biller provider institution computing system 106 (e.g., the message-enabled transfer circuit 134) sends the transfer request message 702 to the customer device 104, at step 302. In some instances, the message-enabled transfer circuit 134 sends the transfer request message 702 to the customer device 104 in response to receiving a request for a message-enabled transfer from the biller computing system 102. For example, in some instances, the biller computing system 102 determines that a bill associated with the customer is coming due (e.g., based on customer information stored in the customer database 119) and, in response to this determination, sends the request for the message-enabled transfer to the biller provider institution computing system 106. In some instances, the biller computing system 102 sends the request to the biller provider institution computing system 106 in response to an input from an employee at a point of sale (e.g., via a point of sale computing system communicably coupled to the biller computing system 102) indicating that the customer is attempting to make a purchase at the point of sale. In some instances, the message-enabled transfer request sent from the biller computing system 102 to the biller provider institution computing system 106 includes various biller transfer information (e.g., financial account information associated with a financial account of the biller into which the funds are to be transferred into) and, in some embodiments, various biller preferences (e.g., a preferred payment rail of the biller).

In some instances, the biller computing system 102 sends the transfer request message 702 to the customer device 104, at step 302. For example, in some instances, the biller computing system 102 utilizes a website or a banking application (e.g., the biller client application 118) or otherwise communicates with the biller provider institution computing system 106 (e.g., the message-enabled transfer circuit 134) to request the link 704 discussed above. In some instances, the biller computing system 102 sends the request for the link 704 as part of the request for the message-enabled transfer discussed above. Accordingly, in these instances, the biller provider institution computing system 106 generates the link 704 and transmits the link 704 to the biller computing system 102. The biller computing system 102 then embeds the link 704 within the transfer request message and sends the transfer request message to the customer device 104.

With reference again to FIG. 3, in some embodiments, the biller provider institution computing system 106 then receives customer transfer preferences associated with the transfer request from the customer device 104, at step 304, and a transfer confirmation, at step 306. For example, upon the customer clicking on the link 704 provided in the transfer request message 702 on the customer device 104, the link navigates the customer to the website or banking application (e.g., the customer client application 124) and the customer is provided, via the customer device 104, with the “opt in” user interface (e.g., the “opt in” user interface 800) and the transfer user interface (e.g., the transfer user interface 900) discussed above.

As shown in FIG. 8, in some embodiments, within the “opt in” user interface 800, the biller provider institution computing system 106 (e.g., the message-enabled transfer circuit 134) provides the customer with a link 802 configured to allow the customer to view the terms and conditions associated with the message-enabled transfer service. The “opt in” user interface 800 further provides an “opt in” button 804 configured to allow the customer to affirmatively opt in to the message-enabled transfer service (e.g., thereby consenting to the terms and conditions) and a cancel button 806 configured to allow the customer to exit the website or banking application.

In some instances, upon clicking on the “opt in” button 804 within the “opt in” user interface 800, the user is then navigated to the transfer user interface (e.g., transfer user interface 900). In some other instances, the customer may “opt in” to the message-enabled transfer service prior to actually conducting a transaction or a bill coming due. Accordingly, in these instances, the transfer user interface 900 is generated and sent from the biller provider institution computing system 106 (e.g., the message-enabled transfer circuit 134) to the customer device 104 at a later time (e.g., when the customer is conducting a transaction or a bill comes due). In any case, the transfer user interface 900 is configured to provide a request for payment (RFP) to the customer via the customer device 104.

As shown in FIG. 9, the transfer user interface 900 provides detailed payment information 902 pertaining to the requested transfer. For example, in some instances, the biller provider institution computing system 106 (e.g., the message-enabled transfer circuit 134) receives the detailed payment information 902 from the biller computing system 102 as part of the request for the message-enabled transfer and generates the transfer user interface 900 based, in part, on the received detailed payment information 902. In some instances, the detailed payment information 902 includes an identification of the biller, an amount due for payment, and a description of the service or product associated with the payment. In some instances, the detailed payment information 902 includes various additional details pertaining to the payment.

In some instances, the transfer user interface 900 additionally includes various selectable payment methods 904 and various selectable payment rail options 906 associated with the various selectable payment methods 904 that are configured to allow the user to select a desired payment method (e.g., a bank routing number and account number, a payment token associated with a financial account, a transfer service identifier associated with a transfer service, a credit or debit card, etc.) from which the customer would like to have funds transferred to the biller and a desired payment rail (e.g., an RTP rail (e.g., a real-time credit push to the biller), an ACH rail, a pay-with-Zelle® rail, the FedNow™ payment rail, a card-based payment rail, etc.) over which the customer would like to have funds transferred.

In some instances, the selectable payment methods 904 and/or the selectable payment rail options 906 correspond to the customer eligibility report discussed above. That is, in some instances, after generating the customer eligibility report for a given customer, as discussed above with respect to FIG. 2, the message-enabled transfer circuit 134 is configured to store the customer's available payment methods and corresponding payment rail options and associate them with the customer within a database of or communicably coupled to the biller provider institution computing system 106 to be utilized when generating the transfer user interface 900. In some other instances, the selectable payment methods 904 and/or the selectable payment rail options 906 are received by the message-enabled transfer circuit 134 as part of the request for the message-enabled transfer.

In some instances, the transfer user interface 900 additionally includes a “new payment method” button 908. For example, upon clicking the “new payment method” button 908, the customer is allowed to provide a new payment method for use with the message-enabled transfer. In some instances, the customer device 104 receives the new account information (e.g., a routing number, a financial account number, a debit card number, a credit card number, a transfer service identifier, etc.) manually from the customer via a touchscreen (e.g., one of the I/O devices 120) of the customer device 104. In some other instances, the customer device 104 receives the new account information via a camera (e.g., one of the I/O devices 120) of the customer device 104 that is used by the customer to scan in a new payment method, such as a debit or credit card number scanned from the debit or credit card. In yet some other instances, the customer device 104 receives the new account information using a near-field communication (NFC) device (e.g., one of the I/O devices 120) via an NFC transmission when the customer taps the customer device 104 (e.g., the NFC device) to a payment card having NFC capabilities (e.g., a smart card) to capture a payment token associated with the payment card. In some cases, once the customer has provided the new account information, the customer device 104 again displays the transfer user interface 900 with the new payment method added as a new payment account option (e.g., similar to the selectable payment methods 904).

In some instances, the transfer user interface 900 further includes selectable payment frequency options 910 that allows the customer to specify whether the customer would like to make a one-time payment or a recurring payment. For example, in some instances, the customer may be making a purchase at a merchant point of sale (e.g., associated with the biller). The biller computing system 102 may then send a message (e.g., the transfer request message discussed above, with reference to FIG. 3) to the customer (e.g., the customer device 104). The customer device 104 may then receive the message and click the link 704 to make the one-time payment. In some instances, the customer may alternatively select the recurring payment to set up an auto-pay (e.g., for rent, a monthly service, etc.) over a given payment rail.

Additionally, the transfer user interface 900 includes a payment frequency input box 912. If the customer selects the recurring payment option, the payment frequency input box 912 is configured to receive a specified payment frequency from the customer (e.g., weekly, monthly).

In some instances, the transfer user interface 900 further includes a “confirm” button that, when clicked on by the customer, is configured to confirm the customer transfer preferences (e.g., the desired payment account, the desired payment rail (if applicable), and the payment frequency) and the customer's desire to initiate the transfer (e.g., the payment). Upon the customer clicking the “confirm” button, the customer device 104 transmits the customer transfer preferences and the transfer confirmation to the biller provider institution computing system 106 (e.g., the message-enabled transfer circuit 134).

It will be appreciated that the “opt in” user interface 800 and the transfer user interface 900 shown in FIGS. 8 and 9 are provided as illustrative examples, and are not meant to be limiting. As such, in some instances, the “opt in” user interface 800 or the transfer user interface 900 may include additional information and/or options or may be configured or arranged differently. For example, in some instances, the transfer user interface 900 may further allow for the customer to select one or more backup payment methods (e.g., via corresponding backup payment method selection buttons) for use in the case that the primary payment method selected is unsuccessful or unavailable. Further, in some instances, the transfer user interface 900 may further allow for the customer to set up a delayed one-time payment. In these instances, the transfer user interface 900 may further include a “delayed one-time payment” option and an input box configured to receive a desired payment time from the customer. For example, if the user's bill for a given service is due in a week, the customer may set up a delayed one-time payment ahead of time to be enacted on or shortly prior to (e.g., one or two days before) the due date for the bill.

Referring back to FIG. 3, once the biller provider institution computing system 106 has received the customer transfer preferences, at step 306, and the transfer confirmation, at step 308, the biller provider institution computing system 106 (particularly the message-enabled transfer circuit 134) transfers the resources (e.g., the funds or payment), at step 308. For example, in some instances, the biller provider institution computing system 106 (e.g., the message-enabled transfer circuit 134) transfers the resources based on one or more of the customer transfer preferences, the biller transfer preferences, or an availability of payment rails for a given transfer.

For example, in some instances, the biller provider institution computing system 106 transfers the resources according to the customer transfer preferences. In these instances, the biller provider institution computing system 106 (e.g., the message-enabled transfer circuit 134) initiates a transfer of resources (e.g., the amount due for payment) from the financial account associated with the payment method selected by the customer to a financial account of the biller over the payment rail selected by the customer.

In some instances, the biller provider institution computing system 106 (e.g., the message-enabled transfer circuit 134) transfers the resources based on a combination of the customer transfer preferences and the biller transfer preferences. For example, if the customer has indicated a real-time payment rail as a primary payment rail selection and an ACH payment rail as a secondary payment rail selection, and the biller has indicated that a real-time payment rail may not be used for a given payment, the biller provider institution computing system 106 (e.g., the message-enabled transfer circuit 134) initiates the transfer of resources over the ACH payment rail.

In either case, the biller provider institution computing system 106 (particularly the message-enabled transfer circuit 134) may alter the transfer method of the resource transfer based on an availability of payment rails. In some instances, the biller provider institution computing system 106 (particularly the message-enabled transfer circuit 134) is configured to progress through the various transfer methods and payment rails (e.g., the potential payment channels) to identify the most efficient route (e.g., based on availability of different transfer methods and payment rails, a desired payment timing, etc.). For example, if the customer has indicated a real-time payment rail as a primary payment rail selection, an ACH payment rail as a secondary payment rail selection, and a card-based payment rail as a tertiary payment rail selection, the biller has indicated a real-time payment rail may not be used for a given payment, and the biller provider institution computing system 106 (e.g., the message-enabled transfer circuit 134) determines that the ACH payment rail is unavailable, the biller provider institution computing system 106 (e.g., the message-enabled transfer circuit 134) initiates the transfer of resources over the card-based payment rail.

Accordingly the message-enabled transfer service provided by the biller provider institution computing system 106 (e.g., the message-enabled transfer circuit 134) enables a variety of selectable transfer methods over a variety of selectable payment rails. It will be appreciated that, while only certain payment methods and payment rails may be discussed herein, in some embodiments, a variety of additional or alternative payment methods and payment rails may be utilized in accordance with the present disclosure, as desired for a given application.

Referring to FIG. 4, a flow diagram of a method 400 for performing a repayment process associated with the message-enabled transfer service is shown, according to an example embodiment. As shown, the method 400 begins by the biller computing system 102 or the biller provider institution computing system 106 (particularly the message-enabled transfer circuit 134) receiving a repayment request (e.g., a claim for repayment/reimbursement), at step 402. In some instances, the repayment request includes various information pertaining to the requested repayment. For example, in some instances, the repayment request includes identifying information associated with the customer (e.g., name, phone number, e-mail address), information relating to the requested repayment or product being returned (e.g., a repayment amount), and information relating to why the customer is requesting repayment (e.g., “I didn't receive my product,” “I was mistakenly charged,” “I am returning a product”).

In some instances, the repayment request is received by the biller computing system 102 from the customer device 104 (e.g., via one of the customer client applications 124 provided by the biller computing system 102). In some other instances, the repayment request is received by the biller computing system 102 as an input from an employee at a point of sale (e.g., via a point of sale computing system communicably coupled to the biller computing system) during a customer interaction (e.g., if the customer physically returns an item). In some instances, the biller computing system 102 then transmits the repayment request to the biller provider institution computing system 106 (e.g., the message-enabled transfer circuit 134). In some other instances, the repayment request is received by the biller provider institution computing system 106 (e.g., the message-enabled transfer circuit 134) directly from the customer device 104 via the network 112.

In some instances, upon receiving the repayment request, the biller provider institution computing system 106 (particularly the message-enabled transfer circuit 134) then determines the customer's eligibility for repayment, at step 404. In some instances, this determination is made based on a type of repayment being requested. For example, in some instances, the message-enabled transfer service allows repayments only for products or services that were originally paid for using the message-enabled transfer service. Accordingly, in some instances, the biller provider institution computing system 106 determines whether the customer utilized the message-enabled transfer service to originally pay for a product or service based on one of information contained within the repayment request (e.g., a receipt associated with the message-enabled transfer service) or a transfer history associated with the customer (e.g., retrieved from the account database 132 or a similar database storing message-enabled transfer service customer information based on a customer identifier provided within the repayment request). If the biller provider institution computing system 106 determines that the customer paid for the original product or service using the message-enabled transfer service, the biller provider institution computing system 106 then determines that the customer is eligible for repayment for the product or service using the message-enabled transfer service.

In some embodiments, once the biller provider institution computing system 106 (e.g., the message-enabled transfer circuit 134) determines that the customer is eligible for repayment, at step 404, the biller provider institution computing system 106 (e.g., the message-enabled transfer circuit 134) then sends or transmits a repayment transfer approval request to the biller computing system 102, at step 406. In some instances, the repayment transfer approval request includes the various information in the repayment request (e.g., identifying information associated with the customer, information relating to the requested repayment/product or service being returned, and information relating to why the customer is requesting repayment).

In some embodiments, the biller provider institution computing system 106 (e.g., the message-enabled transfer circuit 134) then receives a repayment transfer approval from the biller computing system 102, at step 408. In some instances, the repayment transfer approval includes one or more approved repayment methods (e.g., one or more approved repayment accounts from which and payment rails through which the repayment is to be transferred). In some instances, in the case that the repayment request is sent from the biller computing system 102 to the biller provider institution computing system 106 (e.g., the message-enabled transfer circuit 134), the biller computing system 102 sends the repayment transfer approval to the biller provider institution computing system 106 along with the repayment request to indicate that the requested repayment transfer is approved by the biller. As such, in these instances, the biller provider institution computing system 106 (e.g., the message-enabled transfer circuit 134) sending or transmitting the repayment transfer approval request to the biller computing system 102 at step 406 may be omitted.

In some embodiments, the biller provider institution computing system 106 (e.g., the message-enabled transfer circuit 134) then initiates a transfer of resources from the biller to the customer, at step 410. For example, in some instances, the biller provider institution computing system 106 (e.g., the message-enabled transfer circuit 134) initiates a transfer of resources based on one or more of the customer transfer preferences, the biller transfer preferences, or an availability of payment rails for the repayment transfer, as discussed above, with respect to step 308 of the method 300.

It will be appreciated that the method 400 for performing the repayment process associated with the message-enabled transfer service allows for customers to conduct a variety of repayment requests. For example, if a customer has set up a recurring payment using the message-enabled transfer service to pay a rental company (e.g., the biller) for a monthly rent payment and the customer moves out but is subsequently wrongly charged, the customer is allowed to submit a repayment request using the customer device 104, which is then sent to the biller provider institution computing system 106 (e.g., the message-enabled transfer circuit 134), as discussed above, with respect to step 402. Accordingly, the biller provider institution computing system 106 (e.g., the message-enabled transfer circuit 134) then determines the customer's eligibility for repayment, at step 404, and sends the repayment transfer approval request to the biller computing system 102, at step 406. Then, if the biller provider institution computing system 106 (e.g., the message-enabled transfer circuit 134) receives the repayment transfer approval, at step 408, indicating that the rent was, in fact, wrongly charged and approving the repayment request, the biller provider institution computing system 106 (e.g., the message-enabled transfer circuit 134) transfers the resources (e.g., the amount of rent wrongly charged) back into the financial account of the customer.

In some instances, the biller provider institution computing system 106 (e.g., the message-enabled transfer circuit 134) is configured to receive the repayment request, send the repayment transfer approval request, and/or receive the repayment transfer approval from the biller computing system 102 via a third-party application provided by a third-party entity (e.g., a repayment claim handling entity) or using functionality of the third-party application using an API (e.g., integrated into the message-enabled transfer circuit 134) to allow for repayment requests (e.g., claims for repayments/reimbursements) to be automatically processed via the third-party entity (e.g., a third-party computing system associated with the third-party entity.

Referring to FIG. 5, a flow diagram of a method 500 for registering and maintaining a biller receivables account associated with the message-enabled transfer service is shown, according to an example embodiment. As shown, the method 500 begins by the biller provider institution computing system 106 receiving a biller registration request from the biller computing system 102, at step 502. For example, in some instances, the biller computing system 102 sends the biller registration request to the biller provider institution computing system 106, which is received by the receivables processing circuit 136. In some instances, the biller registration request is a request from the biller to register for a biller receivables account with the biller provider institution associated with the biller provider institution computing system 106.

In some instances, the biller receivables account is a financial account held at the biller provider institution (e.g., stored within the account database 132) that is configured to receive various transfers from customers associated with various message-enabled transfers (e.g., using the message-enabled transfer process discussed above). In some instances, the biller receivables account is configured to be used to make various payments (e.g., repayments to customers). For example, in some instances, the receivables processing circuit 136 is configured to selectively cause the message-enabled transfer circuit 134 to initiate commercial electronic office debit payments (e.g., via an ACH rail or a transfer service) and/or real-time payment credits using resources (e.g., funds) stored within the biller receivables account to various customer accounts upon receiving a request from the biller computing system 102. As will be described below, with reference to steps 508-514, in some instances, the biller receivables account is further configured to be monitored by the receivables processing circuit 136 to provide various alerts, prompts, and reports.

In some instances, the biller registration request received from the biller computing system 102 by the receivables processing circuit 136 includes various biller receivables account information to be applied to the requested biller receivables account. For example, in some instances, the biller receivables account information includes one or more customers to be billed, a billing schedule associated with each of the one or more customers, various customer account information associated with each customer (e.g., the various customer account information described above with respect to FIG. 2 used to enable each customer to have their respective eligibilities for the message-enabled transfer service assessed), various customer transfer preferences associated with each customer (e.g., as described above, with respect to FIG. 3), and so on.

In some embodiments, the biller provider institution computing system 106 (e.g., the receivables processing circuit 136) then creates a biller receivables account associated with the biller, at step 504. For example, the receivables processing circuit 136 generates and stores a new biller receivables account within the account database 132. In some instances, the receivables processing circuit 136 further associates the biller receivables account information received from the biller computing system 102 with the new biller receivables account.

In some embodiments, once the biller provider institution computing system 106 (e.g., the receivables processing circuit 136) has created the biller receivables account, at step 504, the biller provider institution computing system 106 (e.g., the receivables processing circuit 136) then monitors the biller receivables account to ensure that the various scheduled customer transfers successfully take place. For example, in some instances, the receivables processing circuit 136 is configured to automatically initiate a message-enabled transfer process for each customer as their respective scheduled transfers (e.g., bills) come due. For example, upon scheduled transfers coming due, the receivables processing circuit 136 causes the message-enabled transfer circuit 134 to send a customer transfer request message to one or more customer device 104 associated with corresponding customers. The message-enabled transfer circuit 134 then receives customer transfer preferences and a transfer confirmation from the one or more customer devices 104 and initiates the transfer of resources (e.g., the payment for the bill) from each corresponding customer financial account to the biller financial account.

Upon a successful or unsuccessful transfer of resources, the receivables processing circuit 136 is configured to update the biller receivables account, at step 508. For example, upon the successful or unsuccessful transfer of resources, the receivables processing circuit 136 receives an indication of the successful or unsuccessful transfer from the message-enabled transfer circuit 134 and stores that indication within the account database 132 (e.g., noting that the scheduled payment either has been paid or was unsuccessful). If a scheduled payment has not been paid by the scheduled due date, the receivables processing circuit 136 is configured to identify the scheduled payment as an outstanding transfer request, at step 510. In some instances, the receivables processing circuit 136 is configured to again update the biller receivables account to reflect that the scheduled payment is outstanding or late (e.g., similar to the updating at step 508).

In some embodiments, the biller provider institution computing system 106 (e.g., the receivables processing circuit 136) then provides a receivables notification to the biller computing system 102, at step 512. For example, in some instances, the receivables processing circuit 136 generates and transmits a receivables report to the biller computing system 102 regarding the identified outstanding transfer requests, at step 514. In some instances, the receivables report includes a variety of information pertaining to the various customers (e.g., a customer identifier associated with each customer, a payment identifier associated with each customer, an indication of whether each customer has opted in to the message-enabled transfer service, etc.), scheduled payments (e.g., successful transfers, unsuccessful transfers, outstanding or late payments, an indication of the service provided for each scheduled payment), and/or any other relevant information. For example, in some instances, the receivables report includes a list of each customer and a list of corresponding scheduled payment statuses (e.g., upcoming scheduled payments, indications that scheduled payments have been successfully paid, indications that one or more customers have outstanding (e.g., late) scheduled payments). In some instances, the indications that scheduled payments have been successfully paid additionally include indications of the payment rails used to conduct the payments. In some instances, the indications that one or more customers have outstanding scheduled payments are organized toward the top of the receivables report or are otherwise flagged within the receivables report (e.g., highlighted, bolded, etc.).

It should be appreciated that the message-enabled transfer service provided by the message-enabled transfer circuit 134 and the biller receivables account provided and monitored by the receivables processing circuit 136 beneficially allow for the tracking of various electronic transfers (e.g., bill payments) using a variety transfer methods (e.g., real-time payment transfers, transfer service identifier-based transfers, ACH transfers, card-based transfers) over a variety of different payment rails (e.g., real-time payment rails, ACH rails, FedNow™ payment rails, pay with Zelle®, card-based payment rails) within a single system (e.g., the biller provider institution computing system). Accordingly, the biller provider institution computing system 106 does not need to pull in or otherwise retrieve bill-pay information from separate, disparate systems to track the various electronic transfers using the variety of transfer methods over the variety of different payment rails. Thus, the bandwidth usage and corresponding power consumption associated with pulling or retrieving bill pay information from separate, disparate systems is effectively eliminated by the biller provider institution computing system 106, while still allowing for customers to selectively utilize a variety of different transfer methods (e.g., payment account types) and payment rails.

In some instances, the receivables processing circuit 136 is configured to perform one or more of the aforementioned functionalities using a third-party application provided by a third-party entity (e.g., an electronic receivables account application provider) or using functionality of a third-party application via an API (e.g., integrated into the receivables processing circuit 136).

Referring to FIG. 6, a flow diagram of a method 600 for identifying and correcting fraudulent transfers associated with the message-enabled transfer service is shown, according to an example embodiment. As shown, the method 600 begins by the biller provider institution computing system 106 (e.g., the fraud detection circuit 138) is configured to monitor transfer information associated with the message-enabled transfer service, at step 602. For example, in some instances, the fraud detection circuit 138 is configured to receive the transfer information from the message-enabled transfer circuit 134 in real-time as various transfers are conducted by the message-enabled transfer service. In some instances, the transfer information received by the fraud detection circuit 138 includes customer financial account information for each customer (e.g., bank routing and account numbers, transfer service identifiers, active payment tokens, credits or debit card numbers, etc.), indications of successful transfers and corresponding transfer details (e.g., methods of payment used, payment rails used, customer identifiers associated with payments), global positioning system (GPS) data associated with the customer devices (e.g., customer device 104) requesting or attempting to initiate the transfers, network connectivity data associated with transfers (e.g., internet protocol (IP) addresses associated with customer devices used to initiate the transfers), merchant identifiers associated with transfers (e.g., names of the merchants paid by the customers), as well as any other pertinent transfer information, as desired for a given application.

In some embodiments, the biller provider institution computing system 106 (e.g., the fraud detection circuit 138) then identifies potential fraud conditions, at step 604, and one or more corresponding potentially fraudulent transfers, at step 606, based on the transfer information. For example, in some instances, the fraud detection circuit 138 is configured to compare an IP address used (e.g., pulled or received from the customer device 104) to initiate each transfer to a list of known IP addresses associated with bad actors. In some instances, the list of known IP addresses associated with bad actors is stored within an associated database of or communicably coupled to the biller provider institution computing system 106. If any of the IP addresses utilized by any of the customers match any of the IP addresses of the list of known IP addresses associated with the bad actors, the fraud detection circuit 138 identifies that match as a potential fraud condition and identifies the associated transfers as potentially fraudulent.

Additionally, in some embodiments, the fraud detection circuit 138 is configured to compare a location of the customer device 104 (e.g., using global positioning system (GPS) data pulled or received from the customer device 104) at the time each transfer was requested or attempted to an expected geographical region (e.g., a given city, state, or country) associated with the customer and/or a list of known locations associated with bad actors. In some instances, the expected geographical region and/or the list of known locations are stored within an associated database of or communicably coupled to the biller provider institution computing system 106. In some instances, the expected geographical region is received from the customer (e.g., the customer device 104) during the opt-in process for the message-enabled transfer service described above. Accordingly, if the customer device 104 is located outside of the expect geographical region or at a location associated with a bad actor, the fraud detection circuit 138 identifies the location of the customer device 104 as a potential fraud condition and identifies the associated transfers as potentially fraudulent.

Further, in some instances, the fraud detection circuit 138 is configured to detect a high velocity of transfers (e.g., a high number of transfers in a short amount of time) using a particular payment method (e.g., payment account) or over multiple payment methods (e.g., payment accounts) associated with a single customer and identify the high velocity of transfers as a potential fraud condition. For example, in some instances, the fraud detection circuit 138 is configured to receive a notification each time a transfer is performed by the message-enabled transfer circuit 134 including various information pertaining to the transfer (e.g., a payment method utilized, a payment rail utilized, a customer associated with the payment method and/or payment rail utilized). If a particular payment method (e.g., payment account, payment token) associated with a customer is used to make several transfers for payments associated with different customers within a predetermined time period, the fraud detection circuit 138 is configured to identify or otherwise flag this scenario as potentially fraudulent. Similarly, in some instances, if multiple payment methods (e.g., payment accounts) associated with a single customer are used to make several transfers for payments associated with different customers within the predetermined time period, the fraud detection circuit 138 is configured to identify or otherwise flag this scenario as potentially fraudulent.

For example, in some instances, the fraud detection circuit 138 compares the number of transfers conducted using a particular account (e.g., payment account) or using multiple payment methods (e.g., payment accounts) associated with a single customer within the predetermined time period to a preset threshold number that may be indicative of a potentially fraudulent condition. For example, in some instances, the predetermined time period is a day, a week, a month, or any other suitable time period. In some instances, the preset threshold number is five, ten, fifty, or any other suitable threshold number that may be indicative of a potentially fraudulent condition. Accordingly, if a high velocity of transfers is detected, the fraud detection circuit 138 identifies the high velocity of transfers as a potential fraud condition and identifies the associated transfers as potentially fraudulent.

It should be appreciated that, by detecting high velocity of transfers across multiple transfer methods (e.g., payment accounts) associated with a single user, the fraud detection circuit 138 beneficially allows for cross-rail customer fraud detection. That is, because the message-enabled transfer circuit 134 allows for customers to conduct transfers using a variety of different registered or eligible payment accounts associated with multiple different payment rails within a single system and the fraud detection circuit 138 receives a notification for each performed transfer, the fraud detection circuit 138 is able to detect a high velocity of transfers across multiple payment methods and corresponding payment rails associated with a single customer, even though the payment methods utilize different types of payment rails. Beneficially, this prevents potential fraudsters who gain access to multiple customer accounts (e.g., via a data breach of the customer's mobile device) from rotating between payment methods when conducting fraudulent transfers to avoid detection.

In some instances, the fraud detection circuit 138 is configured to determine that a customer validation process or service has failed on a particular transfer attempt or request and identify the failed customer validation process or service as a potential fraud condition. For example, in some instances, the fraud detection circuit 138 is configured to receive an indication from the message-enabled transfer circuit 134 when a transfer is requested or attempted using the message-enabled transfer service. In some instances, the fraud detection circuit 138 then places a temporary hold on the requested or attempted transfer (e.g., via communication with the message-enabled transfer circuit 134) until a customer validation process or service is performed to verify the customer's identity.

For example, in some instances, the fraud detection circuit 138 is configured to perform a customer validation process or service to verity the customer's identity by sending a validation request to the customer device 104 of the customer being validated. In some instances, the validation request includes a request for the customer to provide (e.g., via the customer device 104) various validation or authentication information. In some instances, the validation or authentication information includes a phone number associated with the customer, an address associated with the customer, a password associated with the customer, a one-time password (OTP), or any other relevant validation or authentication information.

Further, in some instances, the customer device 104 includes an OTP application (e.g., one of the customer client applications 124) provided and supported by the biller provider institution computing system 106 (e.g., as part of the registration process for registering form the message-enabled transfer service) configured to receive the OTP that may be provided to the biller provider institution computing system 106 (e.g., the fraud detection circuit 138) as part of the requested validation or authentication information. In some instances, the customer has multiple registered customer devices and the OTP is sent from the biller provider institution computing system 106 to a different customer device than then customer device used to request or attempt the message-enabled transfer, thereby providing an additional layer of security by requiring the customer to have access to both registered devices in order to be validated by the fraud detection circuit 138.

In any case, once the fraud detection circuit 138 has received the requested validation or authentication information, the fraud detection circuit 138 then validates or authenticates the customer based on the validation or authentication information. For example, in some instances, the fraud detection circuit 138 pulls expected validation or authentication information (e.g., a phone number, an address, a password) associated with the customer from the account database 132 or an expected OTP from a corresponding biller provider institution OTP application (e.g., the backend support application associated with the OTP application on the customer device 104) stored on the biller provider institution computing system. In some instances, the fraud detection circuit 138 then compares the expected validation or authentication information and/or the expected OTP with the validation or authentication information and/or OTP received from the customer device 104.

If the expected and received validation or authentication information and/or OTP match, the fraud detection circuit 138 releases the hold on the attempted or requested transfer (e.g., via communication with the message-enabled transfer circuit 134), and the messaged-enabled transfer circuit 134 performs the attempted or requested transfer, as discussed above with respect to FIG. 3. However, if the expected and received validation or authentication information and/or OTP do not match, the fraud detection circuit 138 determines that the customer validation process or service has failed. In some instances, the fraud detection circuit 138 then identifies this failed customer validation process or service as a potential fraud condition and identifies the associated transfers as potentially fraudulent.

In some embodiments, once the fraud detection circuit 138 has identified the potentially fraudulent transfers, at step 606, the fraud detection circuit 138 then verifies the one or more identified potentially fraudulent transfers, at step 610. For example, in some instances, upon identifying one or more potentially fraudulent transfers, the fraud detection circuit 138 transmits a transfer verification request to the customer (e.g., the customer device 104) associated with the potentially fraudulent transfers. In some instances, the transfer verification request includes a request for the customer to verify whether or not each of potentially fraudulent transfers was actually requested or attempted by the customer. If the customer indicates that each of the potentially fraudulent transfers were requested or attempted by the customer, the fraud detection circuit 138 determines that the potentially fraudulent transfers were not fraudulent. However, if the customer indicates that one or more of the potentially fraudulent transfers were not requested or attempted by the customers, the fraud detection circuit 138 is configured to verify those potentially fraudulent transfers as verified fraudulent transfers.

Once the fraud detection circuit 138 has verified one or more potentially fraudulent transfers as verified fraudulent transfers, the fraud detection circuit 138 then initiates one or more fraud correction actions, at step 610. For example, in some instances, the fraud detection circuit 138 initiates a repayment transfer from the biller to the customer, as discussed above with respect to FIG. 4. In some instances, the fraud detection circuit 138 is configured to perform one or more fraudster identification processes based on information associated with the verified fraudulent transfers. For example, in some instances, the fraud detection circuit 138 is configured to identify an IP address associated with the verified fraudulent transfers and to add the IP address to a list of IP addresses of known bad actors (e.g., stored within an associated database of or communicably coupled to the biller provider institution computing system 106). In some instances, the fraud detection circuit 138 is configured to identify a fraudster location associated with the verified fraudulent transfers (e.g., via global positioning system (GPS) data pulled from the customer device 104 used to request or attempt the verified fraudulent transfers and to add the location to a list of known locations associated with bad actors. In some instances, the fraud detection circuit 138 is further configured to alert and to provide the IP address and/or fraudster location to appropriate law enforcement regarding the verified fraudulent transfers.

In some instances, the fraud detection circuit 138 is configured to perform one or more of the aforementioned functionalities using a third-party application provided by a third-party entity (e.g., a fraud detection application provider) or using functionality of a third-party application via an API (e.g., integrated into the fraud detection circuit 138).

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOC) circuits), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR), resistors, multiplexers, registers, capacitors, inductors, diodes, wiring, and so on.

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system) or remotely (e.g., as part of a remote server such as a cloud based server). To that end, a “circuit” as described herein may include components that are distributed across one or more locations.

An exemplary system for implementing the overall system or portions of the embodiments might include a general purpose computing devices in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule-based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and embodiment of the embodiments without departing from the scope of the present disclosure as expressed in the appended claims.

What is claimed is:

1. A method comprising:
receiving, by a provider computing system, customer information associated with a customer from a biller computing system associated with a biller;
transmitting, by the provider computing system, a transfer request message to a customer device;
generating, by the provider computing system, a transfer user interface accessible by the customer device via an embedded link within the transfer request message, the transfer user interface including a plurality of transfer preference options based on the customer information;
receiving, by the provider computing system, a selected transfer preference option from the customer device; and
initiating, by the provider computing system, a transfer from a customer account associated with the customer to a biller account associated with the biller based on the selected transfer preference option.

2. The method of claim 1, wherein the transfer request message is sent as one of a text message, an e-mail message, a push notification, or an instant message.

3. The method of claim 1, wherein the selected transfer preference option comprises a desired customer account from which to transfer a resource to the biller and a desired transfer rail for the transfer.

4. The method of claim 1, further comprising:
receiving, by the provider computing system, a customer eligibility request from one of the biller computing system or the customer device; and
determining, by the provider computing system, an eligibility for message-enabled transfers for one or more customer accounts of the customer based on the customer information.

5. The method of claim 4, wherein the eligibility for the message-enabled transfers for the one or more accounts is performed by initiating a request for transfer of a predefined amount of resources using the customer information to validate the customer information.

6. The method of claim 4, further comprising:
generating, by the provider computing system, a customer eligibility report comprising a list of eligible accounts and transfer rails; and
transmitting, by the provider computing system, the customer eligibility report to the one of the biller computing system or the customer device.

7. The method of claim 4, wherein the plurality of transfer preference options comprise a plurality of accounts determined to be eligible for the message-enabled transfers.

8. A provider computing system comprising:
one or more processing circuits including one or more processors and one or more memories having instructions stored thereon that, when executed by the one or more processors, cause the one or more processors to:
receive customer information associated with a customer from a biller computing system associated with a biller;
transmit a transfer request message to a customer device;
generate a transfer user interface accessible by the customer device via an embedded link within the transfer request message, the transfer user interface including a plurality of transfer preference options based on the customer information;
receive a selected transfer preference option from the customer device; and
initiate a transfer from a customer account associated with the customer to a biller account associated with the biller based on the selected transfer preference option.

9. The provider computing system of claim 8, wherein the transfer request message is sent as one of a text message, an e-mail message, a push notification, or an instant message.

10. The provider computing system of claim 8, wherein the selected transfer preference option comprises a desired customer account from which to transfer a resource to the biller and a desired transfer rail for the transfer.

11. The provider computing system of claim 8, wherein the instructions, when executed by the one or more processors, further cause the one or more processors to:
receive a customer eligibility request from one of the biller computing system or the customer device; and
determine an eligibility for message-enabled transfers for one or more customer accounts of the customer based on the customer information.

12. The provider computing system of claim 11, wherein the eligibility for the message-enabled transfers for the one or more accounts is performed by initiating a request for transfer of a predefined amount of resources using the customer information to validate the customer information.

13. The provider computing system of claim 11, wherein the instructions, when executed by the one or more processors, further cause the one or more processors to:
generate a customer eligibility report comprising a list of eligible accounts and transfer rails; and
transmit the customer eligibility report to the one of the biller computing system or the customer device.

14. The provider computing system of claim 11, wherein the plurality of transfer method options comprise a plurality of accounts determined to be eligible for the message-enabled transfers.

15. One or more non-transitory computer-readable media having instructions stored thereon that, when executed by one or more processing circuits of a provider computing system associated with a provider, cause operations comprising:
receiving customer information associated with a customer from a biller computing system associated with a biller;
transmitting a transfer request message to a customer device;
generating a transfer user interface accessible by the customer device via an embedded link within the transfer request message, the transfer user interface including a plurality of transfer preference options based on the customer information;
receiving a selected transfer preference option from the customer device; and
initiating a transfer from a customer account associated with the customer to a biller account associated with the biller based on the selected transfer preference option.

16. The one or more non-transitory computer-readable media of claim 15, wherein the transfer request message is sent as one of a text message, an e-mail message, a push notification, or an instant message.

17. The one or more non-transitory computer-readable media of claim 16, wherein the selected transfer preference option comprises a desired customer account from which to transfer a resource to the biller and a desired transfer rail for the transfer.

18. The one or more non-transitory computer-readable media of claim 17, the operations further comprising:
receiving a customer eligibility request from one of the biller computing system or the customer device; and
determining an eligibility for message-enabled transfers for one or more customer accounts of the customer based on the customer information,
wherein the plurality of transfer preference options comprise a plurality of accounts determined to be eligible for the message-enabled transfers.

19. The one or more non-transitory computer-readable media of claim 18, wherein the eligibility for the message-enabled transfers for the one or more accounts is performed by initiating a request for transfer of a predefined amount of resources using the customer information to validate the customer information.

20. The one or more non-transitory computer-readable media of claim 19, the operations further comprising:
generating a customer eligibility report comprising a list of eligible accounts and transfer rails; and
transmitting the customer eligibility report to the one of the biller computing system or the customer device.
